(19) United States
(12) Patent Application Publication
(10) Pub. No.: US 2007/0155231 A1
(43) Pub. Date: Jul. 5, 2007

(54) Coaxial cable connector

(76) Inventor: Neil H. Tang, Monroe Township, NJ (US)

Correspondence Address: Kenneth Watov, Esq.;Watov & Kipnes, P.C., P.O. Box 247, Princeton Junction, NJ, 08550, US

(21) Appl. No.: 11/324,812

(22) Filed: Jan. 4, 2006

(51) Int. Cl. H01R 9/05

(52) U.S. Cl. 439/578

(57) ABSTRACT

A coaxial cable female connector for inclusion in a port of a device or outer shell of a cable connector, includes a centrally located female pin within a pin carrier, the pin is rounded and has an upper portion with two opposing resilient arms configured for receiving the central pin of a mating male connector. A bottom end portion of the pin includes a hole for the injection of sealant material to prevent moisture from migrating through the pin into the device or cable to which the pin is connected. The bottom of the pin carrier and the surrounding bottom portions of the pin carrier and port or shell from which the bottom of the female pin protrudes, are coated with sealant to prevent moisture from migrating through the pin carrier and interior walls of the port or shell into the associated device or cable. The connector assembly is mechanically locked into the associated port or shell.

### FIELD OF THE INVENTION

The field of the present invention relates generally to electrical connectors, and more particularly to coaxial cable connectors.

### BACKGROUND OF THE INVENTION

Coaxial cables typically are cables that include the center conductor surrounded by electrically insulated material, typically known as a dielectric material, such as a suitable plastic material. The insulative material is typically itself surrounded by a metal sheath provided in ribbon or braided form. The metal sheath is itself covered by an electrically insulated material, such as a suitable rubber or plastic material. The center conductor of the coaxial cable is typically a highly conductive wire material, usually copper or a copper alloy, but is not limited thereto. Radio frequency signals are typically conducted by the center conductor, whereby the outer metal sheath is typically connected to ground, and provides for electrically or electromagnetically shielding the signal being carried by the center conductor to prevent the signal from emitting radio frequency signals along the length of the cable. Such spurious radiation may interfere with other communications or data transmission. Coaxial cables are used in many different communication systems, such as cable television systems, data transmission systems, telecommunication systems, and so forth.

In any system, incorporating coaxial cable for transmitting signals, cable connectors must be used at the ends of the cable for connecting it to the signal transmission system at one end and the signal receiving system at the other end. The widespread use of cable television systems has caused much research and effort over the years to develop improved connectors for terminating the ends of coaxial cable signal lines. Outdoor terminations of coaxial cable must insure that moisture and other environmental contaminants cannot migrate into the connectors used, and by way of such connectors into the housings of electrical devices themselves having connectors for connecting to the ends of coaxial cable signal lines either directly or via a mating connector at the end of the coaxial cable. Cable television components, for example, such as splitters, attenuators, amplifiers, and so forth, may include housings that have threaded holes for receiving screw-in coaxial cable connectors via threaded holes in the housings, or may include housings that are diecast with connector ports integral with the housing. The screw-in type connectors are typically more expensive than use of connectors build into diecast ports of a housing. Also, the threaded insert connectors present an additional sealing problem to prevent moisture from entering the housing from the area where the connector screws into the threaded hole of a housing. Other housings incorporating diecast connector ports integral with the housing may eliminate moisture entry problems at the point where the connector port meets the housing. However, presently available RF connector mechanisms (coaxial cable connector mechanisms) secured within the integral ports of an RF component housing may still provide a path for moisture to migrate through the interior of the port and the coaxial cable mechanism into the housing of the associated electrical device, causing electrical failure of the device and reliability problems. There is also a need in the art to provide improved coaxial cable termination mechanisms within connectors for making secure mechanical and positive electrical connection to the center conductor of the associated coaxial cable, while at the same time insuring proper impedance matching. It is also important to ensure that the connector mechanisms used for terminating or securing the center conductor of the coaxial cable cannot be pulled out from their associated port or connector housing during use. Another problem in the art is the burden of having to accurately machine the ports of diecast housings to insure proper operation of connector mechanisms. It is also important to ensure that the electrical connection made between the electrical circuitry of the associated electrical component and the connector be free from failure, such as caused by internal movement of the connector mechanism breaking a solder connection between printed circuit board and a centrally located connecting tab or pin of the associated connector mechanism, that itself is electrically connected to the center conductor of the associated coaxial cable. It is preferred to minimize the number of components used in coaxial cable connector mechanisms to both reduce cost and increase reliability. Recent coaxial cable connector designs include a centrally located female pin that receives the end of the center conductor of a coaxial cable for the coaxial cable, or male pin of a coaxial cable male connector, for terminating the same. It is important to prevent the female pins from being able to rotate due to rotation of the associated coaxial cable, or to rotation of the mating connector as it is connected to the connector of the associated electrical device. It is also important that the female pin make maximum mechanical and electrical contact with a male pin or directly with the center conductor of a coaxial cable.

### SUMMARY OF THE INVENTION

With the problems of a prior art in mind, it is an objective of the present invention to provide an improved coaxial cable connector.

Another object of the invention is to provide an improved coaxial cable connector that can readily be sealed against the incursion of moisture through the connector into the housing of an associated electrical device.

A further object of the invention is to provide an improved coaxial connector that is mechanically held in position for preventing the associated mechanism from being pulled out of its housing or outer port.

Yet another object is to reduce the burden of having to machine the interior portions of the ports of diecast housings to obtain proper electrical connector operation.

With these and other objects in mind, and with the problems of the prior art in mind, in one embodiment of the invention a female connector mechanism for retention in either a threaded connector shell for screwing into the housing of an electrical device, or for installation into the diecast connector port integral with the housing of an electrical device, includes a centrally located round female pin retained within a pin carrier between two resilient opposing arms in an uppermost portion thereof, the bottommost portion being configured for frictionally securing the connector mechanism within the outer shell providing a connector housing. The outer shell or port provides both mechanical and electrical connection to an outer shell of a male coaxial connector, the electrical connection provided being between outer shielding and/or a source of reference potential, such as ground for example. The upper portion of the pin includes two opposing round spring-like arms configured for receiving therebetween the end of the center connector of a coaxial cable or the associated central pin of a mating male coaxial connector, in this example. The resilient arms of the pin carrier are made from a single piece of material, and include two opposing finger-like pawls juxtaposed to opposite sides of the resilient arms in alignment with a gap between the resilient arms. A cap is installed over the top portions of the resilient arms and the female pin, and juts partly out of the outer shell or housing of the connector. The top of the cap includes a centrally located hole configured for guiding the center conductor of a coaxial cable or male pin of a mating male connector into the central portion of the female pin of the present connector. The cap is configured to move downward, exert an inward force on the resilient arms of a pin carrier as the mating connector shell is screwed onto the shell of the present connector, for ensuring very positive mechanical and electrical connection between the center conductor of the coaxial cable and the female pin of the present connector mechanism. The cap also includes in one embodiment of the invention holes proximate its bottom portion for receiving the pawl fingers of the pin carrier, for both providing retention of a cap within the associated connector shell, and for limiting downward motion of the cap only to the extent necessary for moving the resilient arms of the pin carrier inward, for insuring the previously mentioned mechanical and electrical connection between the associated female pin and the center conductor of the associated coaxial cable or mating male connector. The female pin includes a side hole for mating with an inwardly directed detent projection of the pin carrier for preventing rotation of the female pin within the pin carrier. In another embodiment of the invention, the female pin is provided with a hole proximate the point where the bottom portion of the female pin protrudes out of the pin carrier, for permitting moisture sealant material to be injected into the pin up to the point where the split arms of the pin reside, and to be injected into the lowermost portion of the pin below the entry hole for sealant, with moisture sealant material also being deposited within the hole from which the bottom of the pin protrudes into the housing of the electrical device, thereby preventing moisture from migrating through the connector mechanism into the housing of the electrical device. In yet another embodiment of the invention, the pin carrier is configured to include a resilient locking ring for securely mechanically retaining the pin carrier within the barrel of the connector port of the electrical device, thereby also ensuring that the connector mechanism cannot be pulled out of the port barrel or longitudinally moved in a manner that may break the connection between the female pin and circuitry within the housing of the electrical device.

### BRIEF DESCRIPTION OF THE DRAWINGS

Various embodiments of the present invention will be described in detail with reference to the accompanying drawings, in which like items are identified by the same reference designation, wherein:

FIG. 1 is a pictorial view of a splitter device incorporating an embodiment of the present invention;

FIG. 2A is front elevational view of a screw-in F-Type coaxial connector, for example, incorporating one embodiment of the invention;

FIG. 2B is a cross-sectional view taken along 2B-2B of FIG. 2A;

FIG. 3 is a pictorial view looking toward the front of the connector of FIG. 2;

FIG. 4 is a pictorial view looking toward the bottom of the connector of FIG. 2;

FIG. 5 is a pictorial view of the assembled outer portion of a coaxial cable connector mechanism for an embodiment of the invention;

FIG. 6 is a pictorial view of the connector mechanism of FIG. 5 in a partially disassembled state;

FIG. 7 is a cross-sectional view of the connector mechanism taken along 7-7 of FIG. 5, as installed in a diecast port;

FIG. 8 is a cross-sectional view of the connector mechanism taken along 8-8 of FIG. 5, as installed in a diecast port, and is 90° displaced from the cross-sectional view of FIG. 7;

FIG. 9 is a pictorial view of a pin carrier element of the connector assembly of FIG. 5;

FIG. 10A is a pictorial view of a female pin for an embodiment of the invention;

FIG. 10B is a top plan view of the female pin of FIG. 10A;

FIG. 10C is a bottom plan view of the female connector of FIG. 10A;

FIG. 11 is a pictorial view of a cap element for the connector of FIG. 5 for an embodiment of the invention;

FIG. 12 is an exploded assembly view of the coaxial cable connector mechanism assembly of FIG. 5;

FIG. 13 is a pictorial view of a partial assembly of the connector mechanism of FIG. 5;

FIG. 14 is a pictorial exploded assembly view of the installation of the connector mechanism of FIG. 5 into the port of a diecast housing of a splitter, for example;

FIG. 15 is a cross-sectional view taken along 15-15 of FIG. 14, with the connector mechanism installed in the port, but with the cap removed;

FIG. 16A is a cross-sectional view of the elements of a coaxial connector assembly installed within a port for yet another embodiment of the invention;

FIG. 16B is a cross-sectional view rotated 90° relative to FIG. 16A;

FIG. 17 is a pictorial view looking toward the bottom of a modified cap for an embodiment of the invention;

FIG. 18 is a partial pictorial view of the bottom of the screw-in connector of FIG. 2 without installation of moisture sealant material;

FIG. 19 is a partial pictorial view of the bottom of the screw-in connector of FIG. 2 with moisture sealant material installed;

FIG. 20 is a cross-sectional view showing the partial installation of a male coaxial cable connector on a female connector for one embodiment of the invention;

FIG. 21 is a cross-sectional view showing final installation of the male coaxial cable connector relative to FIG. 20;

FIG. 22 shows an interior view of a diecast splitter housing for another embodiment of the invention;

FIG. 23 shows a pin carrier for an alternative embodiment of the invention;

FIG. 24A shows a pictorial view of a cap for an alternative embodiment of the invention;

FIG. 24B is a top view of the cap FIG. 24A;

FIG. 24C is a cross-sectional view taken along 24C-24C of the cap of FIG. 24A;

FIG. 24D is a cross-sectional view taken along 24D-24D of the cap of FIG. 24A

FIG. 25 shows a longitudinal cross-sectional view of a port into which a pin carrier and pin for an alternative embodiment of the invention are being inserted;

FIG. 26 shows a longitudinal cross-sectional view taken along 26-26 of FIG. 22 of a port after installation of the pin carrier and pin of the alternative embodiment of the invention relative to FIG. 25;

FIG. 27 is a pictorial view of an assembly of a cap, pin carrier, and pin for an alternative embodiment of the invention;

FIG. 28 is a longitudinal cross-sectional view taken along 28-28 of the assembly of FIG. 27;

FIG. 29 is an enlarged view showing the interior configuration of a device housing at the bottom of a port into which a pin carrier and pin of an alternative embodiment of the invention had been installed;

FIGS. 30A, 30B, 30C, and 30D each show pictorial views taken from different orientations of a pin carrier for a fourth embodiment of the invention;

FIG. 30E is a pictorial view of the pin carrier for the fourth embodiment of the invention with a pin installed, with the view being observed from the same direction as the pictorial view of FIG. 30;

FIG. 31 shows a pictorial view of an assembly of the pin carrier with a pin and cap installed for the fourth embodiment of the invention;

FIG. 32 is longitudinal cross-sectional diagram taken along 32-32 of FIG. 31;

FIG. 33 is a longitudinal cross-sectional pictorial view of a pin carrier with pin assembly installed within a port of a device relative to the fourth embodiment of the invention;

FIG. 34 is a pictorial view of a cap as it is being installed into a port of a device containing the assembly of a pin carrier and pin for the fourth embodiment of the invention; and

FIG. 35 is a partial pictorial cross-sectional diagram showing within a port of a device the assembly of a cap, pin carrier, and pin as installed therein for the fourth embodiment of the invention.

### DETAILED DESCRIPTION OF THE INVENTION

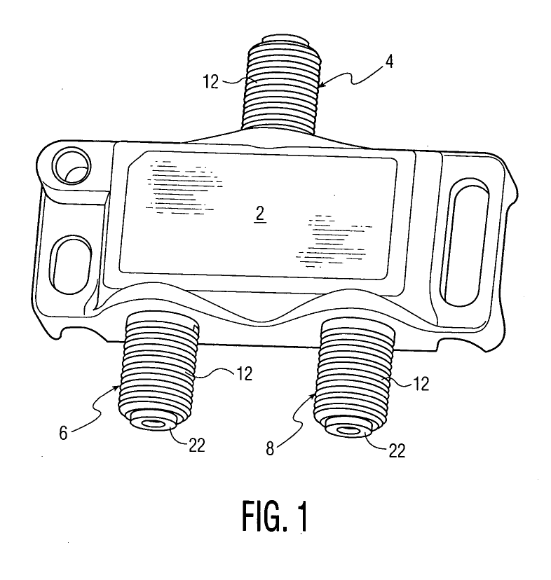

In FIG. 1, a splitter 2 is shown, in this example a two-way splitter that includes an input port 4, and first and second output ports 6, 8, respectively. Each of the ports 4, 6, 8 include threaded barrel 12 enclosing an electrical connector mechanism that includes a cap 22 that has a top end slightly protruding from its associated barrel 12, as shown. The barrels 12 can be included as part of a diecast housing for the splitter 2, or can be provided by separate screw-in type connectors, as will be discussed below. Typically, such ports and connector mechanisms provide F type connectors, but the present invention is not meant to be limited to F type connectors.

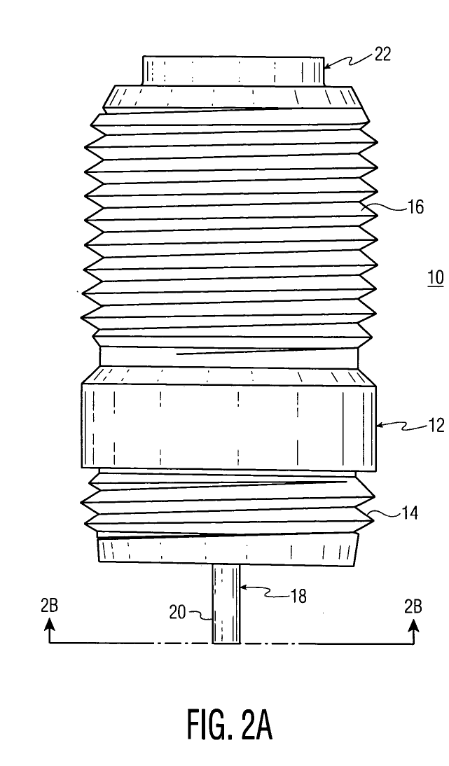

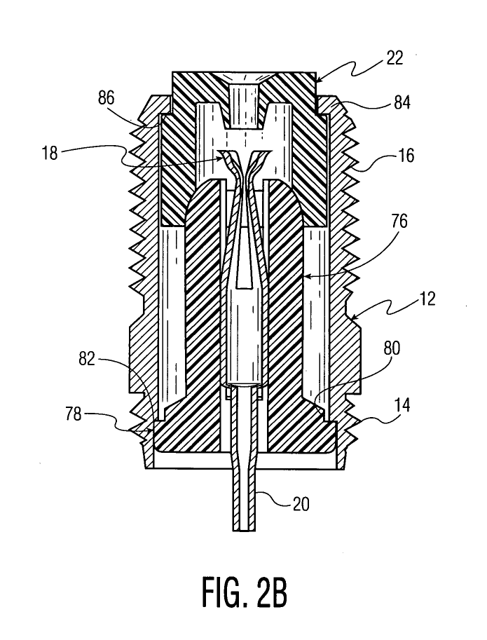

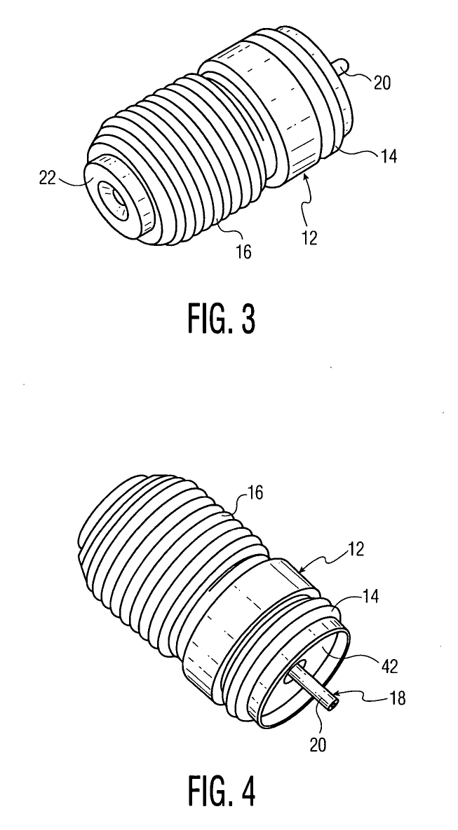

FIGS. 2A, and 2B through 4 show pictorial views of screw-in type connectors, typically F type connectors, that can be secured to housings by screwing the bottom threaded portions 14 into threaded holes of the housing at each port location. As shown, the screw-in electrical connectors each include a barrel 12 having a bottom threaded portion 14, and top threaded portion 16, enclosing an electromechanical connector mechanism. The electrical connector mechanism includes a cap 22, a portion of which is protruding out of the top of the barrel 12, and a centrally located rounded electrical pin 18 having a bottom portion 2Q protruding from the bottom of the barrel 12, as shown, in this example. Note that the electrical pin 18 is not meant to be limited to the rounded pin that will be discussed in detail below. Reference is made to FIG. 2B for a longitudinal cross-section taken along 2B-2B of FIG. 2A. As shown in this example, the connector mechanism includes the cap 22, the rounded electrical pin 18 configured as shown, a pin carrier 76, a lowermost locking ring 78 being provided on the pin carrier 76, with a lower portion 20 of the pin 18 protruding from the bottom of the barrel 12, as previously mentioned. The open top of the barrel 12 includes a peened over portion 84 that abuts against a step-like portion 86 of the cap 22, for slidingly retaining the cap 22 within the barrel 12 as shown. The barrel 12 also has an enlarged bottommost portion 82 for receiving a locking ring portion 78 of the pin carrier 76. The locking ring 78 of pin carrier 76 fits tightly in the enlarged portion 82 of the barrel 12, for providing a frictional fit that prevents longitudinal and rotational movement of the pin carrier 76 within the barrel 12.

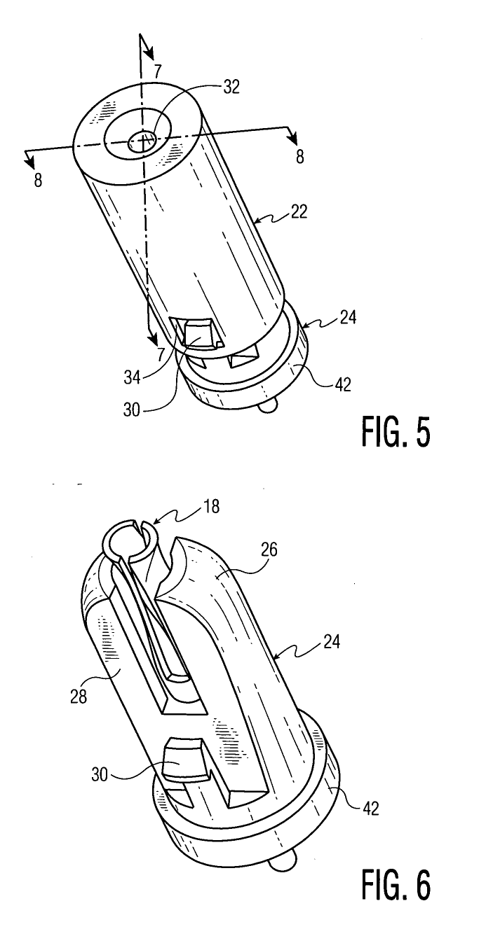

Note that the embodiments of the invention for barrels 12 as shown in FIGS. 2A, and 2B through 4 to provide screw-in parts to an associated housing, typically have a connector assembly inserted into the barrel 12 from the bottom thereof. The embodiments of the invention for FIGS. 5 through 13, described below, can be modified for such bottom insertion into barrels 12 for a screw-in F-connector 10. However, these various embodiments of the present invention as described are preferred, in that they provide for inserting the connector assembly into the top or free end of a barrel or port for reduced cost of assembly and manufacture compared to bottom insertion.

In FIG. 5, a pictorial view of an assembly is shown for a first embodiment of the invention that includes a cap 22 mounted over a pin carrier 24, the latter including a resilient locking ring 42. The cap 22 includes a locking hole 34 for receiving a locking pawl 30 of the pin carrier 24, as shown. The cap 22 also includes an opposing locking hole 34 for receiving an opposing locking pawl 30, which are not shown in FIG. 5, but are on the opposite side. Note also that the top of the cap 22 includes a pin guide hole 32.

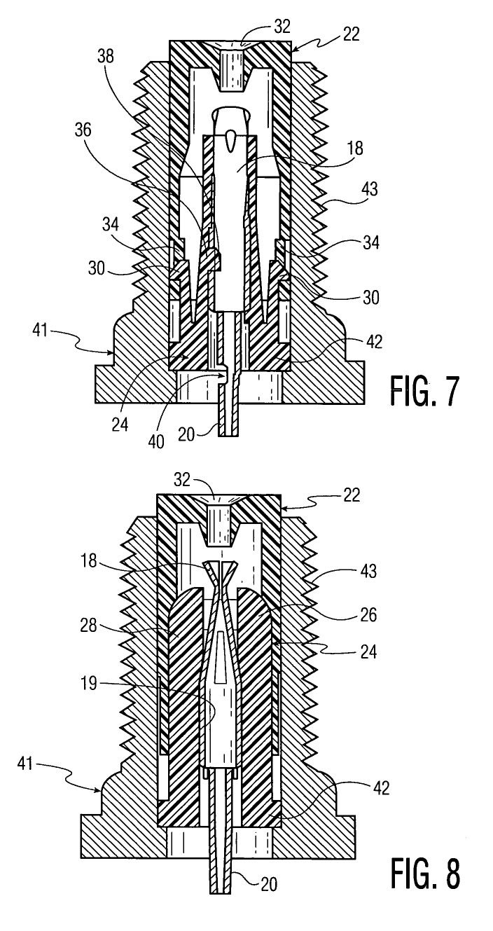

With the cap 22 removed relative to FIG. 5, the first embodiment of the invention, as shown in FIG. 6, further includes a pin carrier 24 configured to include a resilient locking ring 42, and a pair of locking pawls 30, only one of which is shown in the pictorial view. The pin carrier 24 includes opposing resilient arms 26 and 28, between which a rounded electrical pin 18 is mounted, as shown. Note that the locking ring 42 frictionally is retained within the barrel 41 of the diecast housing, as shown in FIGS. 7 and 8.

In FIG. 7, a cross-sectional view of the connector mechanism taken along 7-7 of FIG. 5 is shown, as installed in a threaded barrel 41 of a diecast housing. As shown, pin carrier 24 further includes a detent projection 36 for engagement into a detent side hole 38 of electrical pin 18, for prevention of the pin 18 from rotating within the pin carrier 24, or being pulled out therefrom. The barrel 41 includes an outer threaded portion 43.

FIG. 8 shows a cross-sectional view of the connector mechanism of FIG. 5 taken 11 along cross-section 8-8, which is 90° rotated from the cross section 7-7 of FIG. 5.

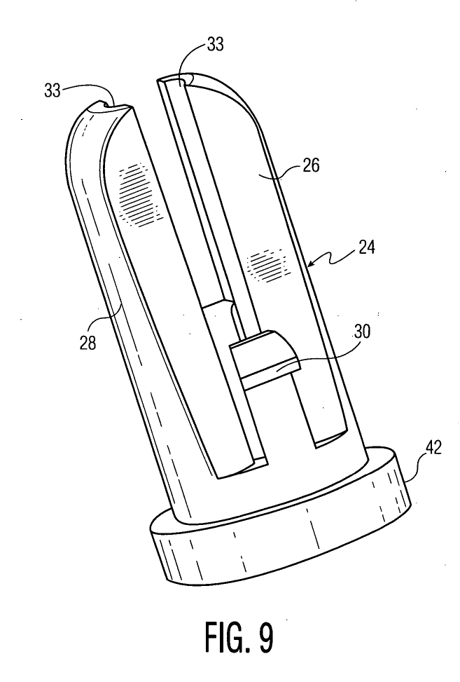

FIG. 9 shows a pictorial view of the pin carrier 24 without the inclusion of an electrical pin 18. Note that the resilient arms 26 and 28 each include longitudinal interior rounded or partially semi-circular grooves 33 for receiving electrical pin 18.

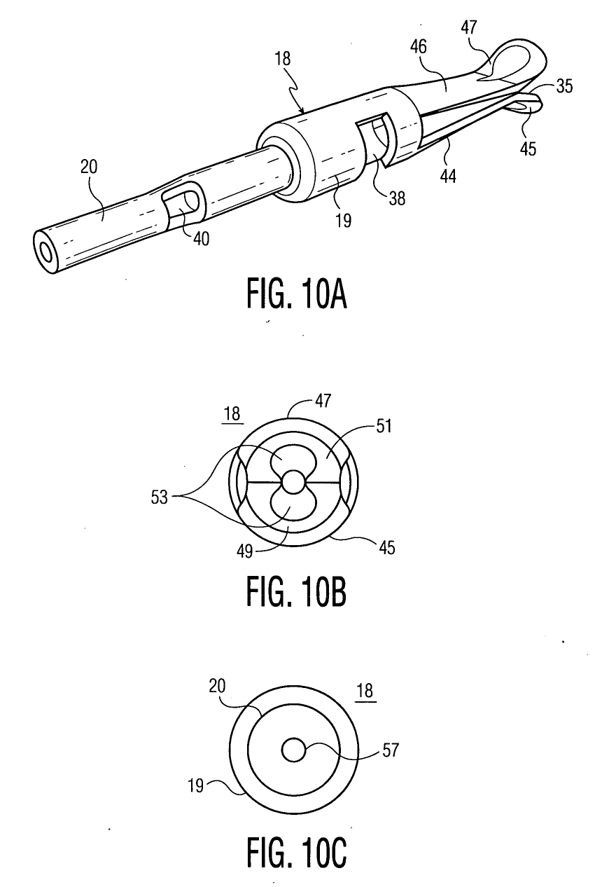

FIG. 10A shows a pictorial view of a rounded female pin 18 for all embodiments of the invention. As shown, the upper portion of the pin includes two opposing rounded spring arms 44, 46, respectively. The top portion of the spring arms 44, 46 each include flared or upwardly diverging end portions 45, 47, respectively, which have their interior opposing surfaces configured to provide a pin guide pathway 35 for receiving the male pin or center conductor of a coaxial cable of a mating male connector, as will be described. The female pin 18 also includes a pin detent side hole 38, and a pin sealant hole 40 proximate the bottom portion 20. The center portion 19 of pin 18 includes the detent hole 38 and has a larger diameter than the bottom portion 20. In FIG. 10B, the top view of the pin 18 shows that the inside wall portions 49, 51 of the flared end portions 45, 47, respectively, are each rounded, concave, and each include a centrally located partially semicircular portion 53. In FIG. 10C, a bottom view of pin 18 is shown. The bottom includes a hole 57 which goes all the way through to the central portion 19 of pin 18.

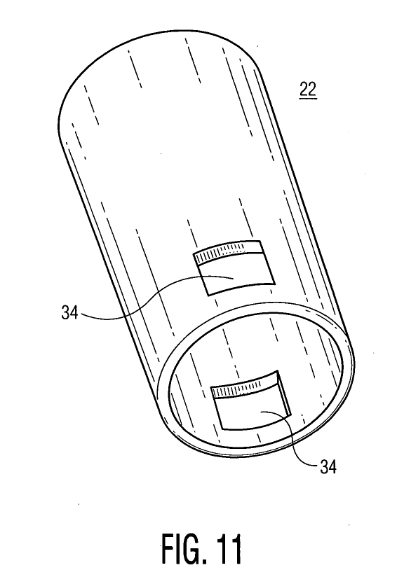

With reference to FIG. 11, a pictorial view of cap 22 is shown. The view clearly shows the opposing locking holes 34, previously described.

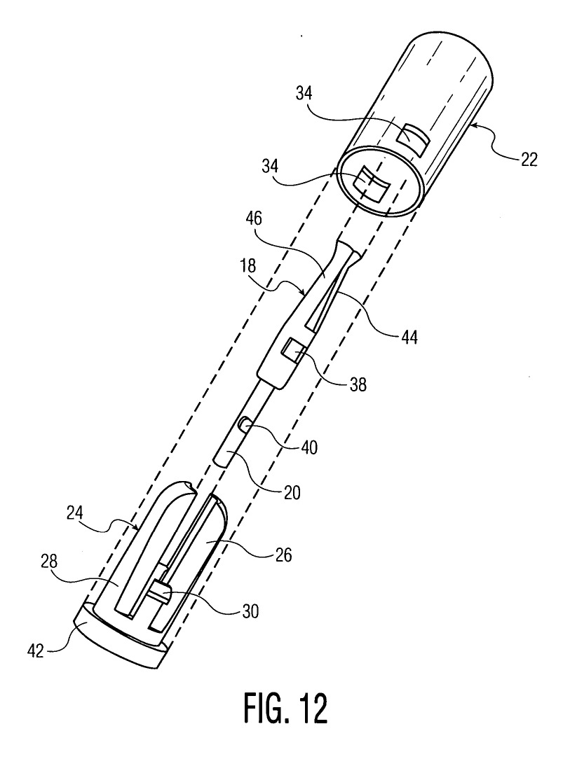

With reference to FIG. 12, an exploded assembly view is shown of the coaxial cable connector mechanism of FIGS. 5 through 9. During assembly, the pin 18 is pushed into the pin carrier 24 and oriented to have the detent projection 36 (not shown) of the pin carrier 24 snap into the pin detent side hole 38 of electrical pin 18. Thereafter, cap 22 is pushed over the assembly of the pin carrier 24 and electrical pin 18, and oriented to cause the pawls 30 of pin carrier 24 to snap into the locking hole 34 of cap 22.

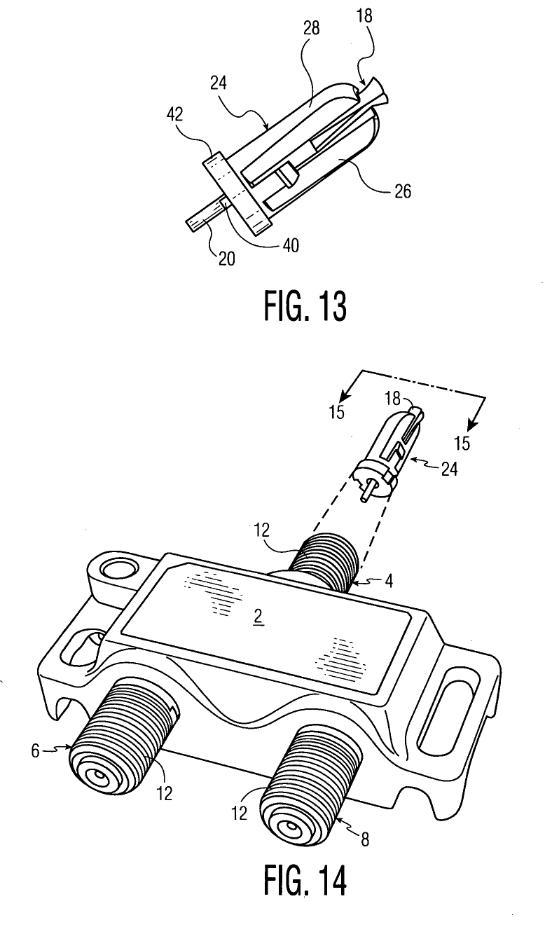

FIG. 13 shows a pictorial view of a partial assembly of the electrical pin 18 as installed in the pin carrier 24 before the cap 22 is installed.

With reference to FIG. 14, an exploded assembly view is shown for installing the assembly of the electrical pin 18, and pin carrier 24 into a barrel 12 of port 4 of splitter 2, in this example. The cap 22 is installed afterward, or alternatively can be installed on the assembly of the pin 18 and pin carrier 24 before installation into a barrel 12 of a port 4, 6, or 8, in this example.

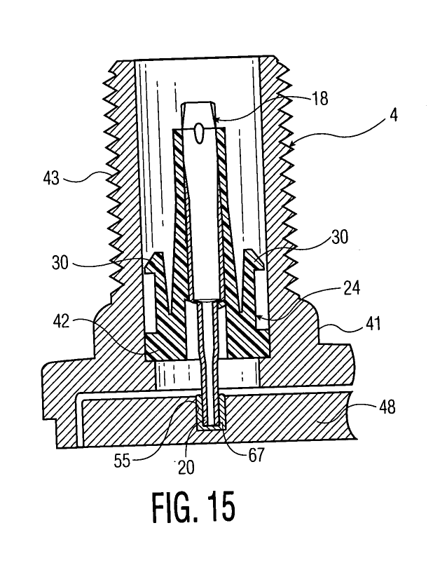

With reference to FIG. 15, a cross-sectional view taken along 15-15 of FIG. 14 is shown, but with the cap 22 removed. In this example, the bottom portion 20 of electrical pin 18 is installed within and soldered via solder 67 to a receiving slot 55 of a printed circuit board (pcb) 48. Typically the lowermost portion 20 of pin 18 is soldered to the linking path of the receiving slot of the printed circuit board 48.

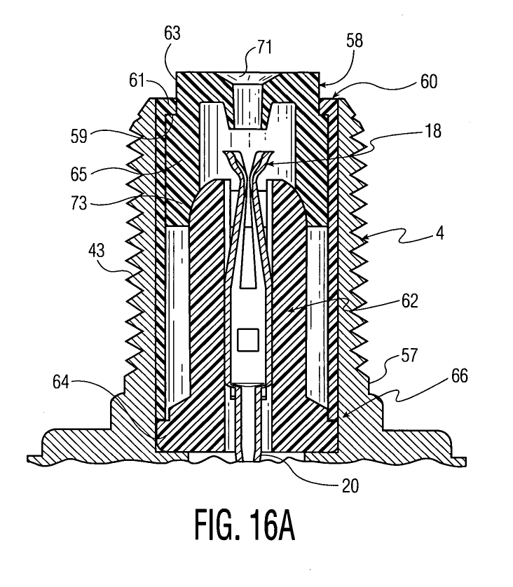

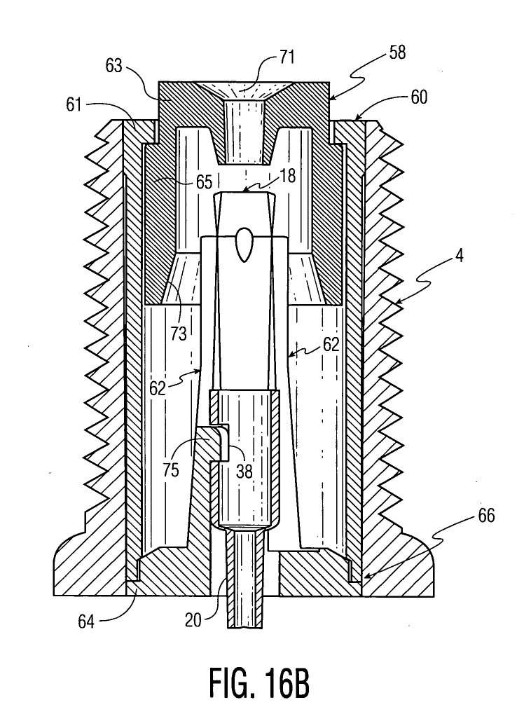

With reference to FIGS. 16A and 16B, in each a partial cutaway is shown of an electrical connector assembly, for a second embodiment of the invention, as installed in a barrel 57 of input port 4 of splitter 2, in this example. FIG. 16B is rotated 90° relative to FIG. 16A. Note that this and other examples of embodiments of the invention in association with the splitter 2 are for purposes of illustration only, and the present invention is not meant to be limited to use with any particular electrical device. In the embodiment of FIG. 16A, a brass insert tube 60 is used to provide accurate machined dimensions for the included modified cap 58, modified barrel 57, and modified pin carrier 62. A step interlock 66 is provided between the bottom portion of pin carrier 62 proximate its locking ring 64. The uppermost portion 61 of brass tube 60 has an inward projecting circular lip for retaining a stepped portion 59 of cap 58 to retain the latter in the barrel 57, as shown. FIG. 16B is the cross-section of FIG. 16A rotated 90°. Note that a detent projection 75 of modified pin carrier 62 engages the detent slot or hole 38 of pin 18 to prevent rotation of the latter.

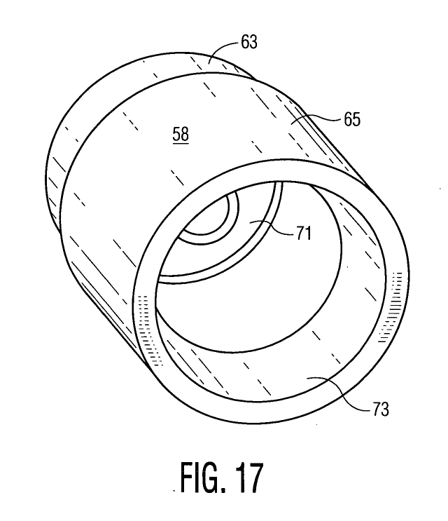

In FIG. 17, a pictorial view of the modified cap 58 is shown looking toward the bottom. Also, with further reference to FIGS. 16A and 16B, the cap 58 includes a top portion 63 of reduced diameter relative to a lower portion 65, as shown. A partially beveled pin guide hole 71 is used to guide a male pin of a mating connector (typically the center conductor of a coaxial cable) through the hole 71 and into electrical pin 18. The lowermost inside wall portion 73 of cap 58 is beveled having an outwardly diverging circular configuration, as shown.

With reference to FIG. 18, the partial pictorial view of the bottom of the connector of FIG. 2 without installation of sealant material is shown. At this point in the assembly of the electrical connector mechanism of the present invention, the bottom 88 of the pin carrier 24, and lower portion 20 of the electrical pin 18 cannot prevent moisture entering into the barrel 12, from migrating into the housing of an electrical device to which the present electrical connector assembly is installed. To prevent such passage of moisture, as shown in FIG. 19, a sealant 90 such as RTV, or an appropriate epoxy, for example, is installed in the bottommost portion of the barrel 12 encapsulating the bottom 88 of pin carrier 24. Also, sealant material is injected into the pin sealant hole 40, and forced through the center of the pin 18 into the central portion 19 of electrical pin 18 for substantially blocking any migration of moisture through the present connector mechanism into the housing of an associated electrical device. FIG. 19 shows the bottom of the barrel 12 after RTV 90, in this example, has been installed over the bottom 88 of pin carrier 24, and also injected into the central portions 19 of the electrical pin 18, as indicated.

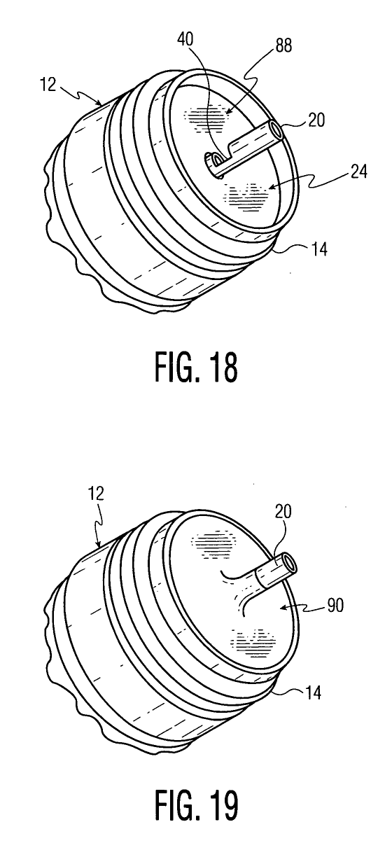

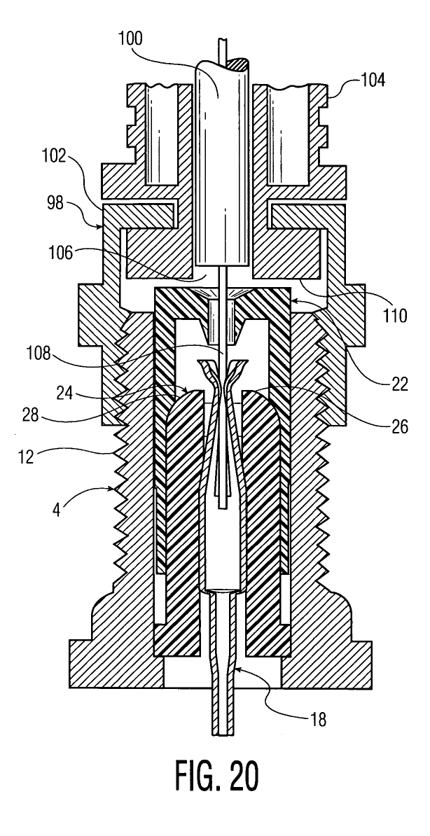

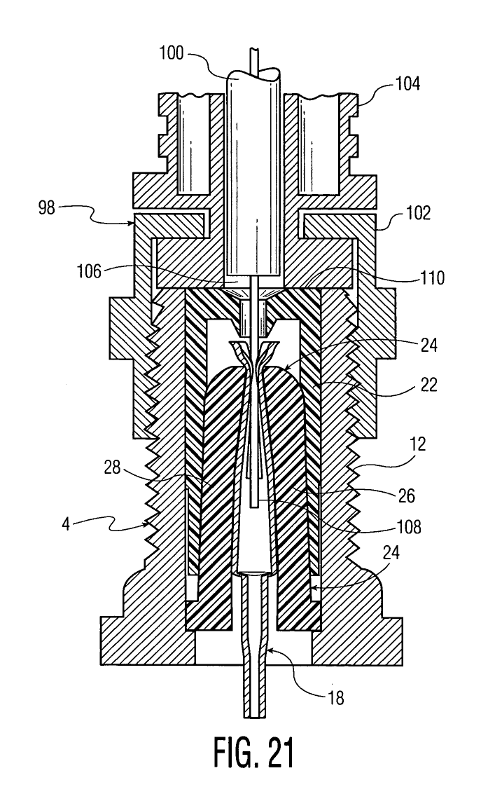

The operation of various embodiments of the invention will now be described. With reference to FIGS. 2 through 4, 8, 10A, 10B, 20, and 21, in this example an F-type male coaxial cable connector 98 has installed therein a coaxial cable 100. As would be known to one of skill in the art, the F-connector 98 includes a nut component 102 for facilitating screwing the connector 98 onto a female F-type connector (see FIG. 20). The nut component 102 is rotatable with and captively retains a cable retention component 104 that includes a centrally located circular cavity 106 for retaining coaxial cable portion 100, typically by crimping the circular cavity tightly around the coaxial cable. Outer insulation of the coaxial cable 100 is removed at an end portion to expose the center conductor 108 of the coaxial cable. The assembly of the male F-connector is installed onto an F-type female port, such as the threaded barrel 12 of the port 4 of FIG. 16, for example. The initial installation of the male F-connector assembly before tightening onto the barrel 12 is shown in FIG. 20. It is important to note that the center conductor 108 of the coaxial cable 100 is pushed into the female pin 18, forcing apart spring arms 44 and 46 of female pin 18, whereby the coaxial cable conductor 108 is mechanically retained and in electrical contact with the semicircular portions 53 of the female pin 18, spring arms 44 and 46. This is an important feature of the present invention, in that even if a push-on type female connector assembly is installed on the port 4, the center conductor 108 or male pin of such a push-on connector will be both in mechanical retention and electrical contact with the female pin 18, ensuring proper electrical operation and continuity between the coaxial cable and the female pin 18. However, the advantage of using the screw-on male F type coaxial cable connector 98 is that after the nut 102 is completely and tightly screwed onto the threaded barrel 12 as shown in FIG. 21, the cap 22 (see FIG. 5) will be pushed downward to the bottom surface of 110 of cable retention component 104, whereby cap 22 will as a result of its downward movement force resilient arms 26 and 28 of pin carrier 24 to move toward one another, in turn forcing spring arms 44 and 46 of female pin 18 to be pushed more closely together in a forceful manner for firmly retaining the center conductor 108 of coaxial cable 100 therebetween. Note that although as previously indicated the push-on F-type male connector assemblies are operative with the present invention, a much more positive mechanical and electrical connection will be made between the female pin 18 and center conductor 108 through use of the screw-on F-type male connector, as immediately described above, for example.

With further reference to FIG. 8, and also to FIG. 7, another important feature of the invention is that sealant material, such as RTV or an appropriate epoxy, for example is first injected into the pin sealant hole 40 (see FIG. 7) in order to cause the sealant to flow into the cavity of the pin 18 for filling both the cavity in the mid-section 19, and the lower portion 20 thereof with sealant material (see FIG. 10A). This injection of sealant material prevents moisture from traveling through the center of the pin 18 into the housing of the associated device. In addition, with reference to FIG. 18, the bottom of the barrel 12 will be left with the bottom 88 of the pin carrier 24 exposed as shown, whereby moisture may still migrate between the inside walls of the barrel down passed the pin carrier 24 into the interior of an housing of associated device. In a further embodiment of the invention, to prevent this, appropriate sealant material 90 such as RTV or an epoxy is injected into the bottom of the barrel 12 for covering the bottom 88 of the associated connector or pin carrier 24, and the pin sealant hole 40, as well as a portion of the bottom 20 of pin 18, for completing the moisture sealing of the associated connector as shown in FIG. 18. In this manner, moisture will be prevented from migrating through the associated connector components into the interior of an associated housing. Note further the use of a sealant material 90 for covering the bottom 88 of pin carrier 24 will also help to more positively retain the pin carrier 24 and its associated components within the barrel 12. In this regard, further note that the bottom portion 20 of female pin 18 is typically soldered into a particular notch hole 53 of an associated printed circuit board 48, as shown in the example of FIG. 15. Also note that sealant material 90 is similarly applied in regard to the alternative embodiment of the invention of FIGS. 16A and 16B.

With further reference to the second embodiment of the invention of FIG. 16A, when an F-type connector is screwed on to the top of the barrel 12, as previously described, the cap 58 only moves downward about one millimeter. In the first embodiment of the invention, particularly as shown in FIGS. 7 and 8, it is very difficult from a manufacturing standpoint to maintain the close tolerances required for the barrel 12, for insuring that the cap 22 shown in FIGS. 7 and 8 has a range of movement of about one millimeter. Through use of the brass insert tube 60, as shown in FIG. 16A, the difficulty of making diecast device housings with integral barrels dimensionally accurate is substantially reduced relative to machining thereof, in that the brass insert tube 60 is very accurately machined and determines the movement of the cap 58, insuring that the cap 58 will have a range of movement of approximately one millimeter. Downward movement in excess of one millimeter may cause damage to the female pin 18, whereas if movement of the cap 22 is restricted to be approximately one millimeter, secure retention of a male pin or a center conductor of a coaxial cable within the pin 18 will be provided, in this example. Accordingly, use of the brass insert tube 60 is a preferred embodiment of the invention. Regardless, for all embodiments of the invention, the associated barrels must be machined to greater or lesser degrees of accuracy.

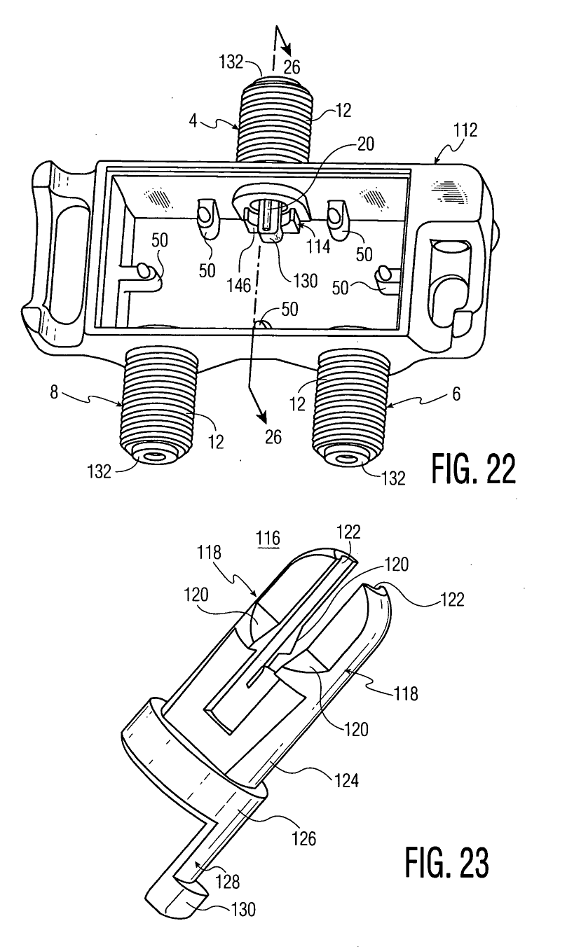

With reference to FIG. 22, an alternative and preferred configuration for the interior of a device housing 112 is shown for a splitter in this example. A preferred embodiment is the inclusion of a sealant box 114, as shown, for receiving sealant material to further ensure that moisture will not be able to migrate into the enclosure of the splitter 112, in combination with the preferred sealing embodiment of the invention, as previously described in association with FIGS. 7, 8, 10A, 17, and 18.

In another preferred, alternative, and third embodiment of the invention, a modified pin carrier 116, as shown in FIG. 23, includes opposing resilient arms 118, each of which includes opposing lower side portion retaining tabs 120, with each arm 118 including an interior semicircular groove 122 for receiving a female electrical pin 18. The resilient arms 118 are formed in this example from a single piece of appropriate plastic material, and project from a lower portion 124, as shown. The bottom of the lower portion 124 terminates at a resilient semilocking ring 126. A locking pawl 128 projects downward from the bottom of the semilocking ring 126. The locking pawl 128 then has its end configured as an outwardly projecting locking tab 130, as shown.

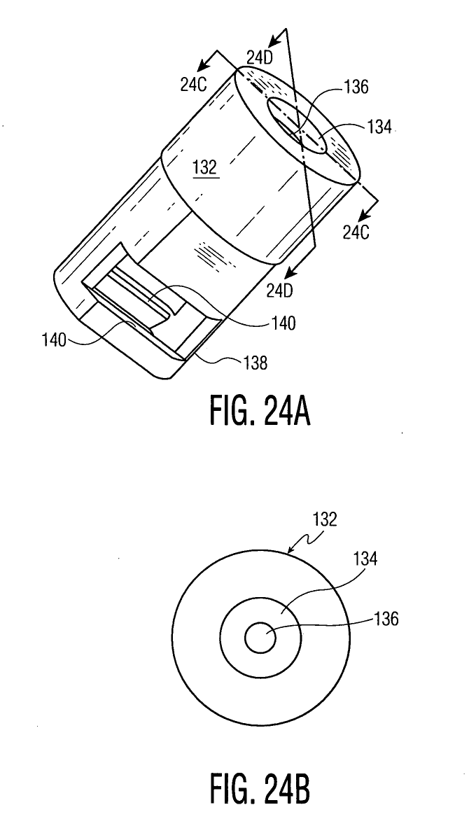

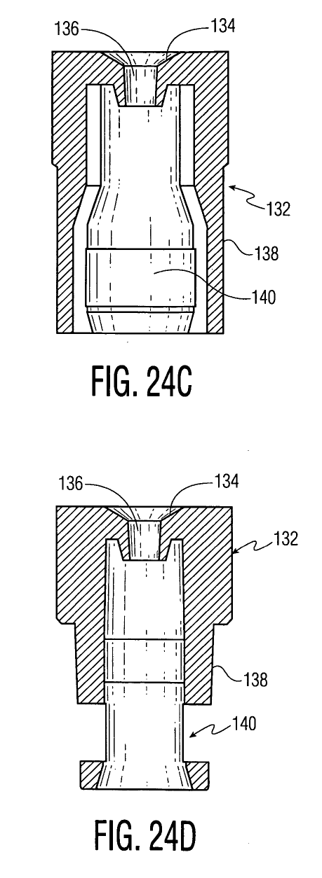

A cap 132 for use in this preferred third embodiment of the invention is shown in FIGS. 24A through 24D, and includes a pin guide hole 136 that has a central beveled portion 134. The lower portion 138 of cap 132 includes triangular shaped opposing through holes or openings 140 for receiving the retainer tabs 120 of the pin carrier 116, as will be further illustrated below.

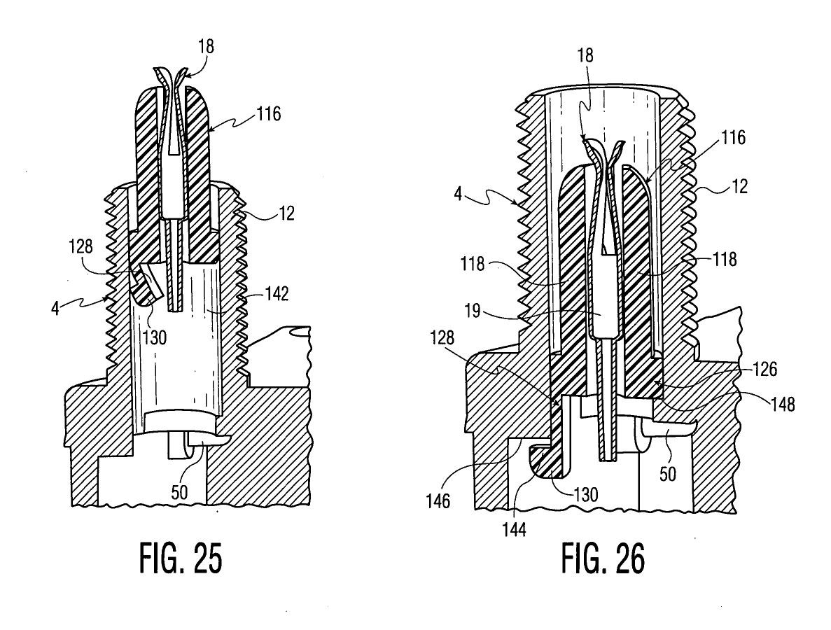

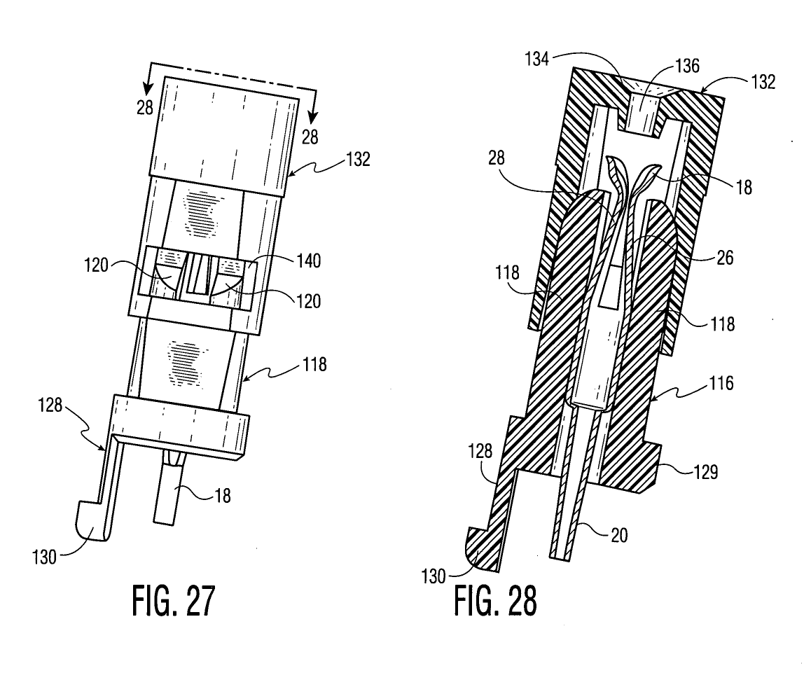

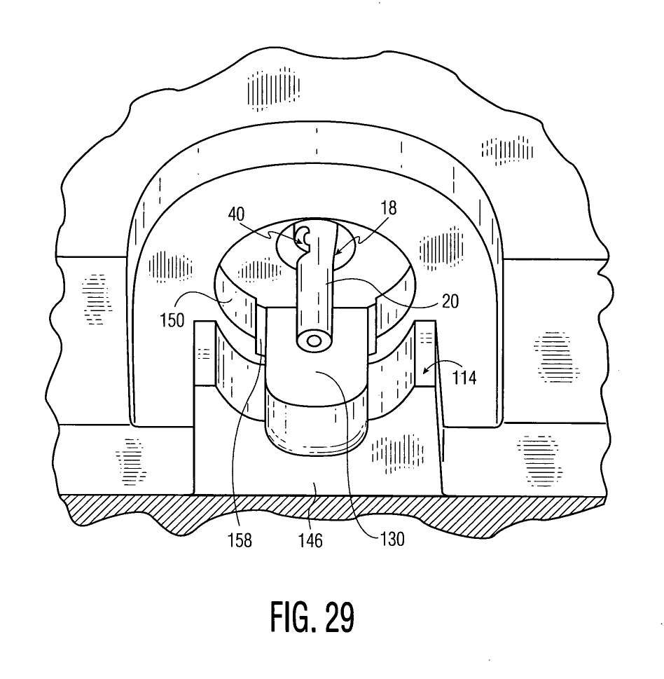

With reference to FIG. 25, a partial longitudinal cross-section of a port, such as port 4 of FIG. 22, is shown, along with a pin carrier 116 with a female electrical pin 18 installed therein. The pin carrier 116 is partially installed within the barrel 12 of the associated port 4, in this example. Further shown, the locking pawl 128 is resilient enough to be bent inward for allowing its locking tab 130 to pass through the interior cylindrical volume 142. of barrel 12, as the pin carrier 116 and its associated pin 18 are pushed downward into the barrel 12. After installation the locking pawl 128 with its locking tab 130 will snap back into a rest position where the stepped portion 144 of locking tab 130 will be abutted against and snapped over a front wall portion 146 of sealant box 114, as shown in FIG. 26 (cross section taken along 26-26 of FIG. 22 absent cap 132), for preventing any chance of the pin carrier 116 from being pulled out of its associated barrel 12. Also, as shown in FIG. 29, locking tab 130 also is located on an optional notch 158 at the bottom of the barrel hole 150 to prevent rotation of the pin carrier 116. Note that the electrical pin 18 is secured to the pin carrier 116 via a detent projection (not shown) substantially the same as the detent projection 36 of pin carrier 24 (see FIG. 7) locking into a detent side hole 38 of female electric pin 18. After the pin carrier 116 along with pin 18 is installed in an associated barrel 12 in this example, the cap 132 is then pushed over the aforesaid assembly, and pushed downward with proper orientation for causing the retaining tabs 120 of pin carrier 116 to snap into the rectangularly shaped retaining holes 140 of cap 132. The assembly of the cap 132 on the pin carrier 116 with pin 18 installed therein is shown in FIG. 27. Assuming that this assembly is installed within a barrel 12, as in the example of FIG. 26, note that the rectangular retaining holes of 140 of the cap 132 are longitudinally wider a sufficient amount more than the width of the retaining tabs 120 for permitting downward movement of the cap 132 a sufficient amount for moving the resilient arms 118 (see FIG. 28, shows a cross section taken along 28-28 of FIG. 27) towards one another a required amount as a result of a male F-type coaxial cable connector being fully installed on the barrel 12, as previously described, for causing the resilient arms 26 and 28 of the pin 116 to compress against the center conductor 108 of a coaxial cable 100, as previously described for the embodiments of the invention of FIGS. 20 and 21. With further reference to FIG. 26, note that the resilient semilocking ring 126 of pin carrier 116 is configured with an outside diameter that in this example provides a snug fit within barrel 12, but permits the pin carrier 116 with pin 18 installed to be easily pushed into the barrel 12 for complete installation with the tab 130 positioned as shown. Further note that the barrel 12 also includes an internal bottommost stepped portion 148 against which a bottom portion of the resilient semilocking rings 126 (opposite locking pawl 128) abuts, for limiting downward movement of the pin carrier 116.

After the assembly of the cap 132, pin carrier 116, and female pin 18 are installed within a barrel 12, sealant material 90 is injected into the pin 18 via pin sealant hole 40, as previously described for other embodiments of the invention. After the sealant material 90 is injected into the pin 18, sealant material is then deposited into the exposed interior volume about hole 150 at the bottom of the associated barrel 12 (see FIG. 29), followed by injecting sealant material 90 into the interior volume of the sealant box 114 for completely sealing the entire bottommost portion of the connector assembly of FIG. 27 within the barrel 12, thereby preventing moisture from migrating through the connector assembly into the interior of the housing of an associated device. Also, a printed circuit board (not shown) has a notch cut into a side portion, for permitting the board to avoid contact with the bottom portion 20 of each pin 18, but have a portion of the board overlying each locking tab 130 when the board is mounted in housing 112 upon standoffs 50. Note that the printed circuit board 48 presses on locking tab 130 to lock it over sealant box 114, thereby holding locking tab 130 down to prevent the pin carrier 116 from being pulled out or rotated. The locking tab(s) 130 is in this manner further restrained from rotating.

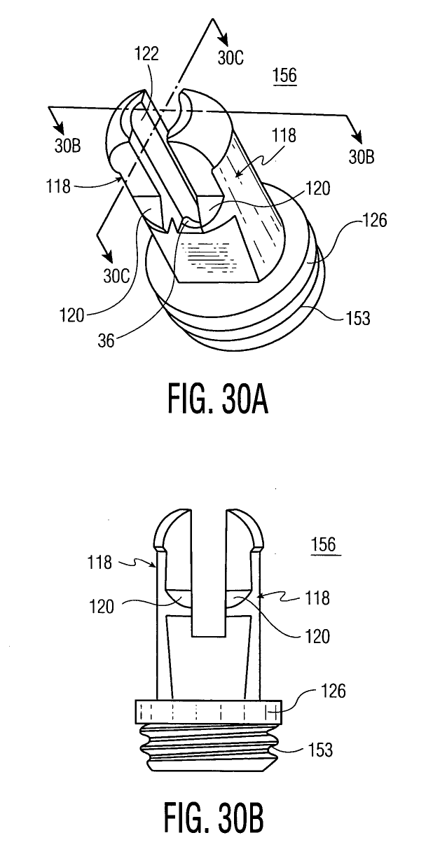

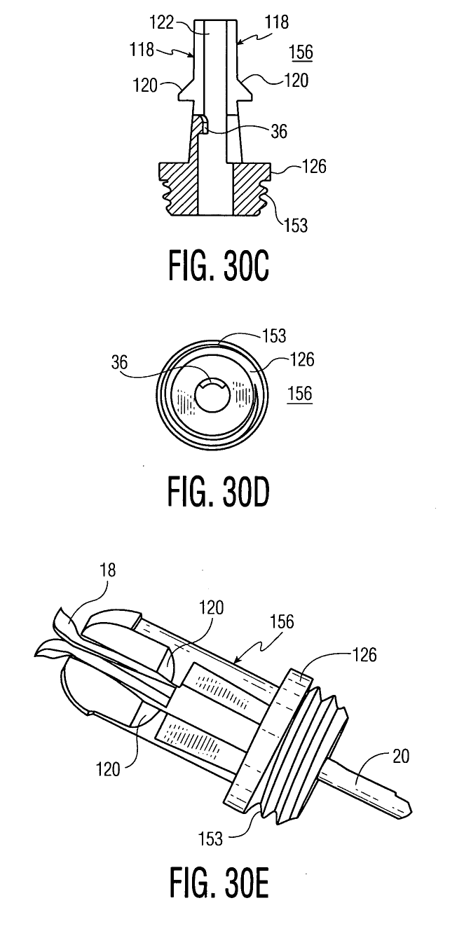

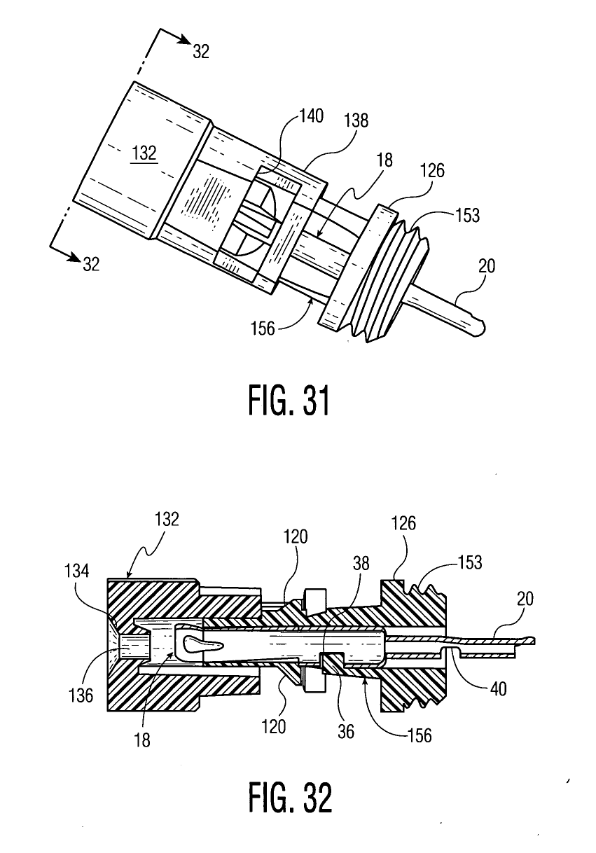

With reference to FIGS. 30A, 30B, 30C, and 30D, pictorial views looking from different directions are shown of a pin carrier 156 for a fourth embodiment of the invention. The configuration of the upper portions of the pin carrier 156 is substantially the same as that of the pin carrier 116 previously described above. The main difference is that the bottom portion of the pin carrier 156 below the resilient semilocking ring 126 includes threads 153. A round electrical pin 18, as used in all embodiments of the invention, is shown installed in the pin carrier 156 in FIG. 30E, with the pin carrier 156 being oriented substantially as in FIG. 30B. This embodiment of the invention uses identical cap 132 as used in the third embodiment of the invention. The cap 132 is shown installed on the pin carrier 156 carrying an electrical pin 18, in FIG. 31. A cross-sectional view taken along 32-32 of FIG. 31 is shown in FIG. 32. Note the detent projection 36 of pin carrier 156 that is locked into the detent hole 38 of pin 18, for preventing rotation of the pin 18 within the pin carrier 156.

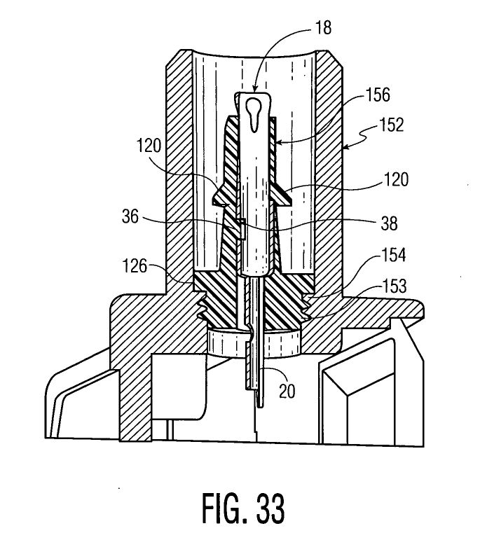

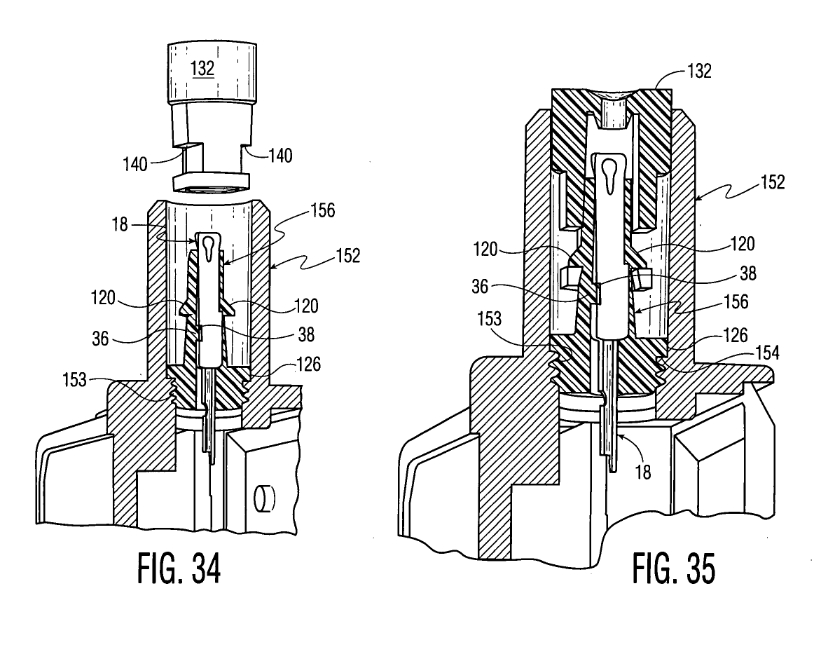

In FIG. 33, a longitudinal partial cross-sectional view is shown of a port 152 having lowermost interior bottom threads 154 for receiving the bottom threads 153 of the pin carrier 156, as shown. In FIG. 34, a cap 132 is positioned for installation into the port 152 onto the pin carrier 156 carrying an electrical pin 18. In FIG. 35, a cross-sectional view is shown of a port 152 containing the assembly of the cap 132 on a pin carrier 156 carrying a pin 18 as installed in the port 152.

The various embodiments of the present invention, as previously mentioned, are not meant to be limited for use with splitters. These embodiments can be utilized with any cable television or RF type devices including female connector ports as herein described for connection to male-type coaxial cable connectors. Also, although various embodiments of the present invention have been shown and described herein, they're not meant to be limiting. Those of skill in the art may recognize certain modifications to these embodiments, which modifications are meant to be covered by the spirit and scope of the pending claims. For example, with reference to the pin carrier 116 of FIG. 22, it can be modified to include two opposing locking pawls 128 each with a locking tab 130, rather than just one locking pawl with associated locking tab 130. Also, rather than serving as connector for the port of an electrical device, the present coaxial cable connector mechanism can be configured to connect to the end of a coaxial cable.

1. A female coaxial cable connector comprising:
a cylindrical housing or shell including centrally located openings in top and bottom portions, respectively, and a centrally located cavity;
a female connector mechanism configured for being securely retained within the cavity of said housing, said mechanism including:
a pin carrier including two spaced apart opposing resilient arms in an uppermost portion thereof, said resilient arms each having a free end, and a lowermost portion having a centrally located through hole, said arms extending from said lowermost portion toward the top of said housing, a bottom portion being proximate the bottom portion of said housing;
a roundly configured electrically conductive female pin including:
two spaced apart opposing spring-like arms in an upper portion configured for receiving therebetween and mechanically engaging an end of a center conductor of a coaxial cable or central pin of a mating male coaxial connector to immediately provide an electrically conductive path therebetween, a circular middle portion from which said spring-like arms extend, a circular lower portion of smaller diameter than and extending from a central portion of said middle portion to a bottom end, and a centrally located through hole extending through said middle and lower portions;
said female pin further including a sealant injection hole through a wall portion of the circular lower portion spaced from the bottom end thereof;
said female pin being securely retained within said pin carrier, with the outwardly flared ends of said female pin being positioned above said resilient arms, the lower portion of said pin protruding away from or out of the bottom portion of said pin carrier, and a centrally located hole in the bottom of said housing;
sealant material, sealant material being injected into said sealant injection through hole of said female pin, said sealant material filling the interior cavities of the middle and lower portions of said pin, for preventing moisture from migrating from the upper portion into the middle portion, and therefrom through the lower portion, into a device associated with said connector; and
a circular cap configured for secure installation over at least top portions of both said resilient arms of said pin carrier, and said female pin, respectively, an upper portion of said cap jutting partly out of the top opening of said housing or shell, a top of said cap including a centrally located hole configured for guiding the center conductor of a coaxial cable or male pin of a mating male connector into the central portion of said female pin, an interior of said cap being hollow with interior walls configured to permit said cap to move downward to exert an inward force on the resilient arms of said pin carrier as a mating male connector is installed onto the housing or shell of said female coaxial connector, for in turn causing said resilient arms to exert an inward force on the spring-like arms of said pin, for obtaining increased mechanical and electrical connection.

2. The connector of claim 1, further including threads about an exterior side portion of said cylindrical housing or shell.

3. The connector of claim 2, wherein said cylindrical housing or shell consists of electrically conductive materials.

4. The connector of claim 1, further including:
said female pin further including an open detent slot in the middle portion thereof; and
said pin carrier further including a detent projection extending from an interior wall portion thereof configured for engaging said detent slot of said female pin for both preventing rotation of the latter, and its pull out from the pin carrier.

5. (canceled)

6. The connector of claim 1, further including:
the lower portion of said female pin protruding from the bottom of said pin carrier being partially surrounded by a circular cavity formed both by the opening in the bottom portion of said housing, and by the bottom of said pin carrier; and
sealant material being injected into the cavity, whereby said sealant material fills the cavity and surrounds an associated portion of said female pin, for preventing moisture from migrating through said housing or shell and said pin carrier into an associated device to which said connector is attached.

7. The connector of claim 1, further including:
said pin carrier further including a pair of opposing pawls extending away from said lowermost portion, and spaced away from and parallel to said resilient arms; and
said cap having side portions including a pair of opposing open slots for receiving and snapping onto end portions of the pair of opposing pawls, respectively, of said cap, thereby securing said cap to said pin carrier, said slots of said cap and said pawls being configured for permitting said cap to move downward a predetermined distance relative to said pin carrier.

8. The connector of claim 1, further including a resilient locking ring about the end of the lowermost portion of said pin carrier, said locking ring being dimensioned to frictionally engage interior wall portions of the cavity of said housing, for securely retaining said pin carrier in said housing.

9. The connector of claim 1, wherein the two opposing spaced apart opposing resilient arms of said pin carrier each have interior semicircular walls for receiving said female pin.

10. The connector of claim 1, further including:
a cylindrically shaped tubular insert dimensioned for being frictionally secured within said housing, said insert having an open bottom, and a top configured to provide an annular ring of reduced diameter relative to the inside diameter of said cylinder, said annular ring being proximate the top portion of said housing;
said cap having an upper portion with an outside diameter that is smaller than the inside diameter of the annular ring of said insert, and a lower portion with an outside diameter that is greater than the upper portion and less than the inside diameter of said insert, whereby said cap is captively retained within said insert;
said pin carrier further including a stepped configuration proximate the bottom of said lowermost portion, whereby the bottom of said insert abuts against the stepped bottom of said pin carrier for securing the bottom of said pin carrier against the bottom of said housing, and the upper portion of said cap protrudes outward from said annular ring of said insert whenever a male connector is not mated to said female coaxial cable connector.

11. The connector of claim 1, further including:
said pin carrier including a locking pawl extending downward away from the bottom of its lowermost portion, a locking tab being at the free end of said locking pawl; and
said housing including a notched cutout in the circumference of the opening in its bottom portion, said cutout being configured for receiving said locking tab of said pin carrier in said housing.

12. The connector of claim 11, further including:
said pin carrier further including our retaining tabs projecting away from and located on opposing sides of each one of said resilient arms, respectively; and
said cap further including on opposing lowermost side portions elongated open slots, whereby each slot is configured for receiving two retaining tabs, one from each said resilient arms, for securing said cap to said pin carrier, said slots being wide enough to allow inward movement of said resilient arms.

13. The connector of claim 1, further including:
said pin carrier further including a male threaded bottommost portion on its lowermost portion; and
said housing further including a female threaded portion proximate its bottom portion for receiving the male threaded bottommost portion of said pin carrier, for securing the latter within said housing.

14. The connector of claim 13, further including:
said pin carrier further including four retaining tabs projecting away from and located on opposing sides of each one of said arms, respectively; and
said cap further including on opposing lowermost side portions elongated open slots, whereby each slot is configured for receiving two retaining tabs, one from each said resilient arms, for securing said cap to said pin carrier, said slots being wide enough to allow inward movement of said resilient arms.

15. The connector of claim 13, further including:
said female pin further including an open detent slot in the middle portion thereof; and
said pin carrier further including a detent projection extending from an interior wall portion thereof configured for engaging said detent slot of said female pin both for preventing rotation of the latter, and its pull out from said pin carrier.

16. (canceled)

17. The connector of claim 13, further including the lower portion of said female pin protruding from the bottom of said pin carrier being partially surrounded by a circular cavity formed both by the opening in the bottom portion of said housing, and by the bottom of said pin carrier; and;
sealant material being injected into the cavity, whereby said sealant material fills the cavity and surrounds an associated portion of said female pin, for preventing moisture from migrating through said housing or shell and said pin carrier into an associated device to which said connector is attached.

18. The connector of claim 13, further including an uppermost portion of said cap being of greater diameter than a lowermost portion.

19. The connector of claim 1, further including:
said free ends of said resilient arms of said pin carrier being rounded; and
an uppermost portion of the interior walls of said cap being of reduced diameter immediately followed by a diverging interior wall portion of greater diameter configured for exerting a radially directed inward force against associated rounded free end portions of said resilient arms respectively, as said cap moves downward upon said pin carrier, thereby causing said resilient arms to move toward one another.

20. The connector of claim 3, wherein said cap consists of electrically nonconductive material.

21. The connector of claim 20, wherein said pin carrier consists of electrically non-conductive material.

22. The connector of claim 1, wherein said pin, said pin carrier, and said cap are each made from a single piece of material.

23. The connector of claim 22, wherein said cap and said pin carrier consist of electrically nonconductive plastic material.

24. The connector of claim 3, wherein said housing consists of diecast metallic material, and further includes:
at least one port containing said female connector mechanism; and
a cavity retaining an electrical device mechanism electrically connected to the lower portion of said pin of said female connector.

25. The connector of claim 3, wherein said housing consists of diecast metallic material, and further includes:
a plurality of ports each containing a said female connector mechanism; and
a cavity retaining an electrical device mechanism having individual electrical connections to the lower portions of said pins of said female connectors, respectively.
